(19) United States
(12) Patent Application Publication
(10) Pub. No.: US 2013/0164008 A1
(43) Pub. Date: Jun. 27, 2013

(54) IMAGE FORMING METHOD

(71) Applicants: Shoko Shimmura, Kanagawa-ken (JP); Satoshi Kinouchi, Tokyo-to (JP); Kazutoshi Takahashi, Shizuoka-ken (JP); Toshihiro Sone, Kanagawa-ken (JP); Ryota Saeki, Shizuoka-ken (JP)

(72) Inventors: Shoko Shimmura, Kanagawa-ken (JP); Satoshi Kinouchi, Tokyo-to (JP); Kazutoshi Takahashi, Shizuoka-ken (JP); Toshihiro Sone, Kanagawa-ken (JP); Ryota Saeki, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/406,858

(22) Filed: Feb. 28, 2012

Related U.S. Application Data
(60) Provisional application No. 61/466,648, filed on Mar. 23, 2011.

(51) Int. Cl. G03G 15/01; G03G 15/08

(52) U.S. Cl. CPC G03G 13/08
USPC 399/53; 399/231; 399/223

(57) ABSTRACT

According to one embodiment, a developing device in which a decolorizable developing agent containing encapsulated colorant microparticles each including a core containing a color developable compound, a color developer, and a decolorizing agent is accommodated and a developing device in which a transparent developing agent containing a binder resin is accommodated are provided, respectively, and an image is formed by transferring a transparent developing agent image onto a region capable of covering a decolorizable developing agent image, followed by fusing the image. Further, in the second image formation and thereafter, the using amount of the transparent developing agent is decreased as compared with that in the first image formation.

### CROSS-REFERENCE TO RELATED APPLICATIONS

This application is based upon and claims the benefit of priority from U.S. Provisional Application No. 61466648, filed on Mar. 23, 2011, the entire contents of which are incorporated herein by reference.

### FIELD

Embodiments described herein relate generally to an image forming method in an electrophotographic process, an electrostatic printing process, a magnetic recording process, etc.

### BACKGROUND

The current situation is such that the amount of information to be dealt with in an office information environment is increasing and the using amount of paper is increasing. On the other hand, reduction of energy consumption typified by CO₂ emission is being studied in various fields. If a recording medium such as paper which is used for temporary display or transfer of information can be recycled, a large contribution can be made to the reduction of energy consumption.

A toner containing a binder resin and a microencapsulated pigment including a color developable agent such as a leuco dye, a color developer, and a decolorizing agent has a characteristic of being colored at normal temperature and decolorized at a given temperature or higher, and therefore, it is possible to reuse a recording medium by decolorizing the contents recorded on the recording medium, and the energy consumption derived from a paper medium can be reduced.

However, the microencapsulated pigment to be used here has a size of 0.5 to 10 μm, which is far larger than that of a pigment to be used in a common toner and having a primary particle diameter of, for example, several nanometers. If the size of the microencapsulated pigment is smaller than the above range, it is not easy to obtain a high-density color developing property, and also the strength of the microencapsulated pigment is not sufficient. Toner particles to be used in an electrophotographic process have an average particle diameter of preferably from 2 to 10 μm, more preferably from 3 to 7 μm for forming high-resolution office documents or photographic images, and therefore, it is not easy to uniformly incorporate a microencapsulated pigment having a large particle diameter in toner particles. In addition, if an image is formed using a toner in which the size of each toner particle and the size of each colorant particle do not make much difference as described above, the colorant particles are liable to be incorporated in the image in a non-uniform state, and it is not easy to control the charging characteristic, fluidity, developing characteristic, and fusing characteristic as the toner. Further, even if colorant particles can be uniformly dispersed in toner particles, it is necessary to coat the colorant particles with a sufficient amount of a binder resin so as not to separate the colorant particles from the binder resin during an electrophotographic process, and therefore, the toner particle diameter is liable to increase, and it is not easy to form high-resolution pictures and images. Further, the colorant particles are liable to be distributed sparsely in the image, and there is a problem that a sufficient image density cannot be obtained.

### BRIEF DESCRIPTION OF THE DRAWINGS

FIG. 1 is an exemplary view showing a schematic structure of one example of an image forming apparatus according to an embodiment.

FIG. 2 is a model diagram showing one example of a way of fusing a secondary developing agent image.

FIG. 3 is a model diagram showing another example of a way of fusing a secondary developing agent image.

FIG. 4 is a diagram showing one example of a uniform pattern of a transparent developing agent.

FIG. 5 is a diagram showing an example of forming an image by applying a developing agent onto the transparent developing agent of FIG. 4.

FIG. 6 is a diagram showing another example of a uniform pattern of a transparent developing agent.

FIG. 7 is a diagram showing an example of forming an image by applying a developing agent onto the transparent developing agent of FIG. 6.

FIG. 8 is a model diagram showing one example of a way of decolorizing a first image.

FIG. 9 is a model diagram showing one example, of a way of fusing a second image.

FIG. 10 is an exemplary view showing a schematic structure of an image forming apparatus according to another embodiment.

FIG. 11 is an exemplary view showing a schematic structure of an image forming apparatus according to still another embodiment.

FIG. 12 is an exemplary view showing a schematic structure of an image forming apparatus according to further still another embodiment.

FIG. 13 is a model diagram showing a way of fusing.

FIG. 14 is an exemplary view showing a schematic structure of another example of an image forming apparatus according to an embodiment.

FIG. 15 is a block diagram showing an image forming mechanism using the apparatus of FIG. 14.

FIG. 16 is a flow chart showing an image forming method using the apparatus of FIG. 14.

### DETAILED DESCRIPTION

In general, according to one embodiment, an image forming method including at least one of first image formation and second image formation is provided.

The image forming method according to a first embodiment includes first image formation and second image formation.

The first image formation includes:

forming a decolorizable first developing agent image by developing an electrostatic latent image formed in accordance with first image information on a first image carrying member using a decolorizable developing agent containing encapsulated colorant microparticles each including a core containing a color developable compound, a color developer, and a decolorizing agent;

forming a first transparent developing agent image by developing an electrostatic latent image formed in accordance with first transparent image information for forming an image capable of covering the first developing agent image on a second image carrying member using a transparent developing agent containing a binder resin;

forming a first transfer image by transferring the first developing agent image and the first transparent developing agent image onto a transfer material; and

fusing the first transfer image onto the transfer material at a fusing temperature.

After forming the first image and before forming the second image, the first image can be optionally decolorized at a decolorizing temperature which is higher than the fusing temperature.

The second image formation includes:

forming a decolorizable second developing agent image by developing an electrostatic latent image formed in accordance with second image information on the first image carrying member using the decolorizable developing agent;

further optionally forming a second transparent developing agent image by developing an electrostatic latent image formed in accordance with second transparent image information which enables the formation of an image capable of covering at least a portion of the second developing agent image on the second image carrying member using the transparent developing agent;

forming a second transfer image by transferring the second developing agent image and the optionally formed second transparent developing agent image onto the transfer material having the first image formed thereon; and

fusing the second transfer image onto the transfer material at a fusing temperature.

In the second image formation, when a ratio of the weight of the transparent developing agent used in the first transparent developing agent image to the weight of the decolorizable developing agent used in the first developing agent image is represented by “first weight ratio” and a ratio of the weight of the transparent developing agent used in the second transparent developing agent image to the weight of the decolorizable developing agent used in the second developing agent image is represented by “second weight ratio”, the second weight ratio is smaller than the first weight ratio. The formation of the second transparent developing agent image is optional, and therefore, it is possible not to form the second transparent developing agent image by setting the weight of the transparent developing agent to 0.

According to the first embodiment, the binder resin in the transparent developing agent is sufficiently supplied onto the transfer material when forming the first image, and therefore, even if the using amount of the transparent developing agent is decreased when forming the second image as compared with the case of forming the first image, the binder resin in the first image melts again at the fusing temperature and contributes to the fusing. Accordingly, the second image can be sufficiently fused.

Further, according to one embodiment, even if an image is repeatedly formed, the using amount of the binder resin is decreased and the thickness of the image becomes not too large.

Further, the image forming method according to a second embodiment includes first image formation or second image formation.

In the second embodiment, whether or not an image including a decolorizable developing agent image and a transparent developing agent image is on a transfer material is detected, and when the image is determined to be not on the transfer material, the above-described first image formation is performed, and when the image is determined to be on the transfer material, the above-described second image formation can be performed.

According to the second embodiment, by detecting in advance the presence or absence of an image formed on the transfer material, the first image formation or the second image formation can be performed as needed, and therefore, the using amount of the binder resin can be efficiently decreased and the thickness of the image can be prevented from becoming large.

According to one embodiment, the first transparent developing agent image can be formed on the first developing agent image or the first developing agent image can be formed on the first transparent developing agent image. In the same manner, the second transparent developing agent image can be formed on the second developing agent image or the second developing agent image can be formed on the second transparent developing agent image.

The image forming method according to a third embodiment is a method when forming the first developing agent image on the first transparent developing agent image, and includes at least the first image formation.

The first image formation according to the third embodiment includes:

forming a first transparent developing agent image having a uniform pattern on a first image carrying member using a transparent developing agent;

forming a decolorizable first developing agent image on a second image carrying member by developing an electrostatic latent image formed in accordance with first image information for forming an image in a region of the first transparent developing agent image using a decolorizable developing agent containing encapsulated colorant microparticles each including a core containing a color developable compound, a color developer, and a decolorizing agent;

forming a first transfer image by transferring the first developing agent image and the first transparent developing agent image onto a transfer material; and

fusing the first transfer image at a fusing temperature.

According to the third embodiment, by forming the first transparent developing agent image having a uniform pattern on the transfer material in advance, a sufficient amount of the binder resin is supplied onto the transfer material, and therefore, the decolorizable first developing agent image formed in a region of the first transparent developing agent image can be sufficiently fused.

In the third embodiment, further, a decolorizable second developing agent image is formed by developing an electrostatic latent image formed in accordance with second image information on a second image carrying member using the decolorizable developing agent, a second transfer image is formed by transferring the second developing agent image onto the transfer material having the first image formed thereon, and a second image can be formed by fusing the second transfer image at a fusing temperature.

In the third embodiment, still further, before forming the second developing agent image, a second transparent developing agent image is formed by developing an electrostatic latent image formed in accordance with second transparent image information using the transparent developing agent at a second weight ratio, which is lower than a first weight ratio, to the weight of the decolorizable developing agent used in the second developing agent image, wherein the first weight ratio represents a ratio of the weight of the transparent developing agent used in the first transparent developing agent image to the weight of the decolorizable developing agent used in the first developing agent image, and the second transparent developing agent image is transferred along with the second developing agent image onto the transfer material having the first image formed thereon, whereby the second transfer image can be formed.

According to the third embodiment, even if an image is repeatedly formed, the using amount of the binder resin is decreased and the thickness of the image does not become too large.

In the first to third embodiments, a first developing device in which the decolorizable developing agent is accommodated and a second developing device in which the transparent developing agent is accommodated can be disposed facing two different image carrying members, i.e., first and second image carrying members, respectively, or the first developing device and the second developing device can be disposed facing one image carrying member (a first image carrying member), i.e., the first image carrying member also has a function of a second image carrying member.

The encapsulated colorant microparticles to be used have a volume average particle diameter of 1 to 10 μm.

If the volume average particle diameter of the encapsulated colorant microparticles is less than 1 μm, it tends to be not easy to control an electrostatically adhering state in the developing and transferring steps. Meanwhile, if the volume average particle diameter thereof exceeds 10 μm, it tends to be not easy to record high-resolution image information.

Hereinafter, embodiments will be described in detail with reference to the accompanying drawings.

Incidentally, the same reference numeral denotes the same element.

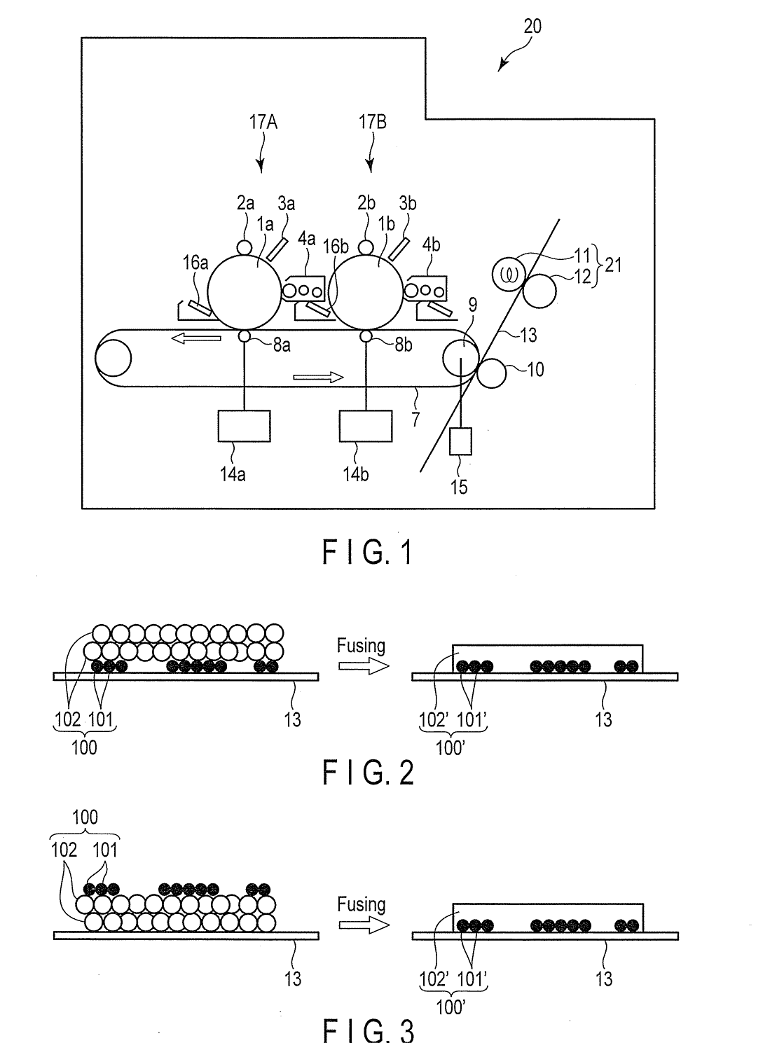

FIG. 1 is a view showing a schematic structure of one example of an image forming apparatus which can be used in an embodiment.

As shown in the drawing, an image forming apparatus 20 has an intermediate transfer belt 7, and also has a second image forming unit 17B and a first image forming unit 17A, which are provided on the intermediate transfer belt 7 in this order, and a fuser 21, which is provided downstream thereof.

The first image forming unit 17A has a photoconductive drum la, and also has a cleaning device 16a, a charging device 2a, a light exposure device 3a, and a first developing device 4a, which are provided on the photoconductive drum la in this order, and a primary transfer roller 8a, which is provided downstream of the first developing device 4a through the intermediate transfer belt 7. In the first developing device 4a, a decolorizable developing agent containing encapsulated colorant microparticles each including a core containing a color developable compound, a color developer, and a decolorizing agent is accommodated.

The second image forming unit 17B has a photoconductive drum 1b, and also has a cleaning device 16b, a charging device 2b, a light exposure device 3b, and a second developing device 4b, which are provided on the photoconductive drum 1b in this order, and a primary transfer roller 8b, which is provided downstream of the second developing device 4b through the intermediate transfer belt 7. In the second developing device 4b, a transparent developing agent containing a binder resin is accommodated.

Downstream of the second image forming unit 17B, a secondary transfer roller 9 and a backup roller 10 are disposed facing each other through the intermediate transfer belt 7.

To the primary transfer roller 8a and the primary transfer roller 8b, a primary transfer power sources 14a and 14b are connected, respectively. To the secondary transfer roller 9, a secondary transfer power source 15 is connected.

The fuser 21 has a heating roller 11 and a pressing roller 12, which are disposed facing each other.

By using the apparatus of FIG. 1, for example, an image can be formed as follows.

First, the photoconductive drum 1b is uniformly charged by the charging device 2b.

Subsequently, light exposure is performed by the light exposure device 3b on the basis of first transparent image information for forming an image capable of covering a first developing agent image to be formed on the basis of first image information in the first image forming unit 17A, whereby an electrostatic latent image is formed.

The electrostatic latent image is developed using a transparent developing agent containing a binder resin, whereby a transparent first transparent developing agent image is formed.

The first transparent developing agent image is transferred onto the intermediate transfer belt 7 using the primary transfer roller 8b.

Subsequently, the photoconductive drum la is uniformly charged by the charging device 2a.

Thereafter, light exposure is performed by the light exposure device 3a on the basis of first image information, whereby an electrostatic latent image is formed.

The electrostatic latent image is developed using a decolorizable developing agent containing encapsulated colorant microparticles each including a core containing a color developable compound, a color developer, and a decolorizing agent, whereby a decolorizable first developing agent image is formed.

The first developing agent image is primarily transferred using the primary transfer roller 8a onto the first transparent developing agent image by adjusting the position of the first developing agent image so that the first developing agent image can be covered with the transparent first transparent developing agent image on the intermediate transfer belt 7.

A primary developing agent image in which the first transparent developing agent image and the first developing agent image are laminated in this order on the intermediate transfer belt 7 is secondarily transferred onto a recording medium 13 through the secondary transfer roller 9 and the backup roller 10, whereby a secondary developing agent image in which the first developing agent image and the first transparent developing agent image are laminated in this order is formed on the recording medium 13.

Subsequently, the secondary developing agent image is fused onto the recording medium 13 by heating and pressing with the heating roller 11 and the pressing roller 12 in the fuser 21, whereby a first image can be formed.

Thereafter, if necessary, by heating the recording medium 13 having the first image formed thereon in a decolorizing device (not shown) at a temperature higher than the fusing temperature, the first image can be decolorized.

Further, by using second transparent image information in place of the first transparent image information, a second transparent developing agent layer is formed in the same manner as the first transparent developing agent image, and by using second image information in place of the first image information, a second developing agent layer is formed in the same manner as the first developing agent image, and a second image can be formed in the same manner as the formation of the first image. At this time, when a ratio of the weight of the transparent developing agent used in the first transparent developing agent image to the weight of the decolorizable developing agent used in the first developing agent image is represented by “first weight ratio” and a ratio of the weight of the transparent developing agent used in the second transparent developing agent image to the weight of the decolorizable developing agent used in the second developing agent image is represented by “second weight ratio”, the second weight ratio is made smaller than the first weight ratio. If necessary, it is possible not to form the second transparent developing agent image by setting the weight of the transparent developing agent to 0.

FIGS. 2 and 3 are each a model diagram showing a way of fusing a secondary developing agent image.

As shown in FIG. 2, by fusing a secondary developing agent image 100 composed of a first developing agent image 101 and a first transparent developing agent image 102 which is laminated on the first developing agent image 101 so as to cover the first developing agent image 101 onto a recording medium, the encapsulated colorant microparticles in a decolorizable developing agent 101′ are not separated from the binder resin in a transparent developing agent 102′ during an electrophotographic process without incorporating the decolorizable developing agent 101′ in a non-uniform state in an obtained image 100′.

Alternatively, as shown in FIG. 3, the secondary developing agent image 100 can be formed by laminating the first developing agent image 101 on the first transparent developing agent image 102. In this case, the secondary developing agent image 100 can be formed by, for example, forming the first transparent developing agent image 102 into a uniform pattern and thereafter forming the first developing agent image 101 in a region of the first transparent developing agent image 102.

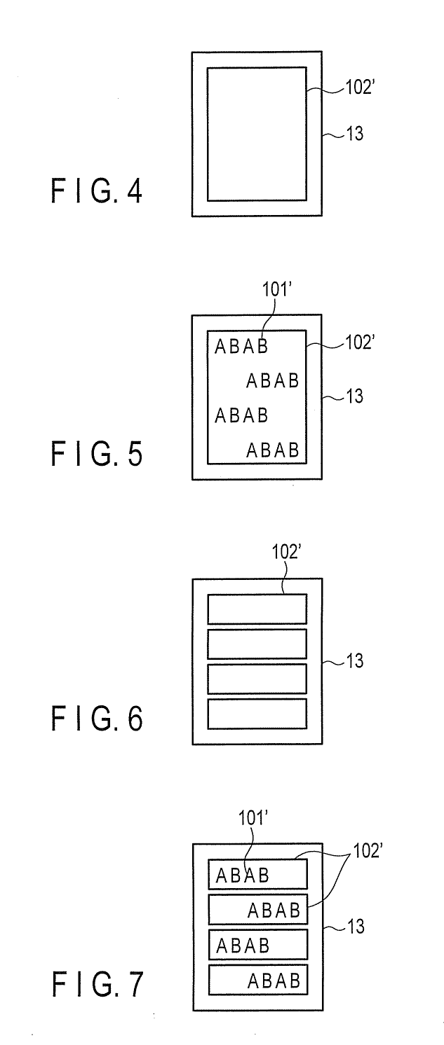

FIG. 4 shows an example of a uniform pattern of a transparent developing agent, and FIG. 5 shows an example of forming an image by applying a developing agent onto the transparent developing agent of FIG. 4.

As shown in FIG. 4, for example, the transparent developing agent image 102′ can be formed into a rectangular pattern. Thereafter, as shown in FIG. 5, an image can be formed by applying the developing agent 101′ in a region of the transparent developing agent image 102′ in a rectangular pattern.

FIG. 6 shows another example of a uniform pattern of a transparent developing agent, and FIG. 7 shows an example of forming an image by applying a developing agent onto the transparent developing agent of FIG. 6.

As shown in FIG. 6, for example, the transparent developing agent image 102′ can be formed into a striped pattern. Thereafter, as shown in FIG. 7, an image can be formed by applying the developing agent 101′ in a region of the transparent developing agent image 102′ in a striped pattern.

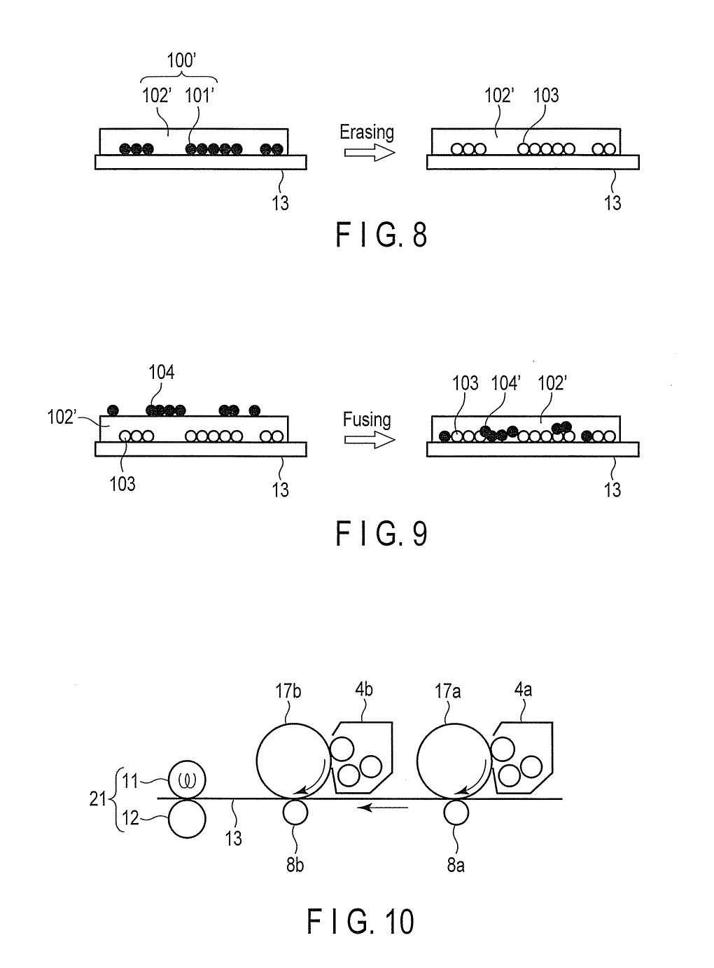

FIG. 8 is a schematic diagram showing a way of decolorizing a first image.

As shown in the drawing, the decolorizable developing agent 101′ in the image 100′ can be decolorized at a decolorizing temperature higher than the fusing temperature in the fuser. The decolorized decolorizable developing agent is indicated by the numeral 103 in the drawing.

The decolorizable developing agent can be decolorized at a decolorizing temperature higher than the fusing temperature in the fuser. The decolorizable developing agent is not decolorized merely by performing fusing at the fusing temperature. Further, the decolorizable developing agent has a hysteresis characteristic of maintaining a decolorized state even if the temperature of the decolorizable developing agent is decreased to a temperature lower than the decolorizing temperature after a decolorizing operation is performed. Preferably, the decolorizing temperature of the decolorizable developing agent can be set to a temperature higher than the fusing temperature in the fuser by 5° C. or more.

If a difference between the decolorizing temperature and the fusing temperature is less than 5° C., due to an effect of a temperature ripple in the fuser or the like, the decolorizable developing agent may be decolorized at the same time of fusing.

The declorizing temperature can be set to, for example, 79 to 103° C.

As shown in FIG. 3, according to the embodiment, the encapsulated colorant microparticles can be arranged at the same layer level on a recording medium, and therefore, a reflected density is higher than in the case where the pigment particles are apart from each other even if the amount of the colorant is the same.

By encapsulating the decolorizing agent, a decolorizing agent which enables decolorization at a specific temperature, a color developer, and a color developable compound can be made to be near each other, and therefore, promptness and completeness of the decolorizing reaction can be expected to be obtained. Further, the embodiment is configured such that the encapsulated colorant microparticles and the binder resin particles are handled as separate developing agents, and the decolorizable developing agent image is covered by applying a pressure to the resin melted by heat in the fusing step, and therefore, the developing and transferring processes can be optimized according to the charging characteristics of the respective particles, as a result, an image can be stably formed.

Further, there is no fear of separation of the encapsulated colorant microparticles from the binder resin particles during the electrophotographic process, the developing amount of the binder resin can be decreased to the minimum capable of adhering the encapsulated colorant microparticles to the recording medium.

FIG. 9 is a schematic diagram showing one example of a way of forming a second image on the decolorized first image.

According to the embodiment, if the binder resin contained in the transparent developing agent 102′ is sufficiently supplied onto the recording medium 13 when forming the first image, it is possible to decrease the using amount of the transparent developing agent when forming the second image as compared with the case when forming the first image. As shown in the drawing, for example, even if the transparent developing agent is not used when forming the second image, the binder resin in the transparent developing agent 102′ in the first image melts again at the fusing temperature and contributes to the fusing of a developing agent image 104. Accordingly, a decolorizable developing agent 104′ in the second image can be sufficiently fused.

FIGS. 10 to 12 are each an exemplary view showing a schematic structure of an image forming apparatus according to another embodiment.

In FIGS. 10 to 12, on each photoconductive drum, a cleaning device, a charging device, and a light exposure device are provided, however, the description thereof is omitted for simplification.

An image forming apparatus shown in FIG. 10 has the same structure as that in FIG. 1 except that the intermediate transfer belt 7 is not provided, the first image forming unit 17A and the second image forming unit 17B are disposed in the opposite order to that in FIG. 1, and the first developing agent image and the first transparent developing agent image are transferred directly onto the recording medium. In FIG. 1, the number of transfer operations is 2, however, in this case, the number of transfer operations is 1, and therefore, as shown in FIG. 10, when the first image forming unit 17A and the second image forming unit 17B are disposed in the opposite order to that in FIG. 1, a developing agent image in which the first developing agent image and the first transparent developing agent image are laminated in this order is obtained on the recording medium in the same manner as shown in FIG. 2.

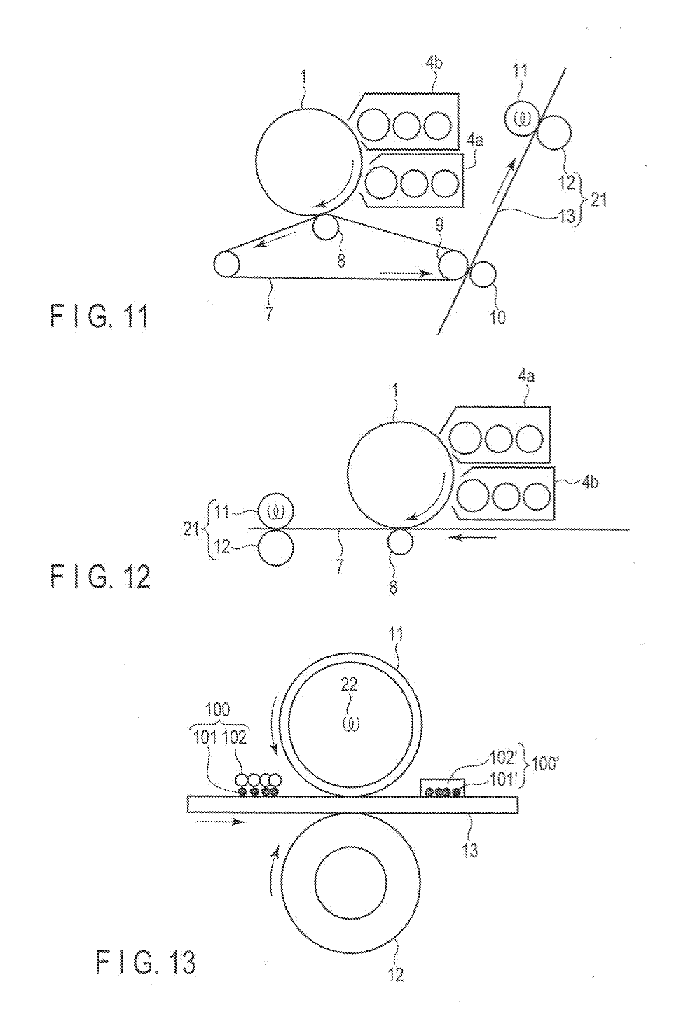

An image forming apparatus shown in FIG. 11 has substantially the same structure as that in FIG. 1 except that the second developing device 4b and the first developing device 4a are disposed facing one photoconductive drum 1 instead that the second developing device 4b and the first developing device 4a are disposed facing two different photoconductive drums, the second photoconductive drum 1b and the first photoconductive drum la, respectively. In this case, on the photoconductive drum 1, the first transparent developing agent image and the first developing agent image are developed in this order and transferred onto the intermediate transfer belt 7 by a transfer roller 8. Further, the developing agent image transferred onto the intermediate transfer belt 7 is transferred onto the recording medium 13 using the secondary transfer roller 9 and the backup roller 10, whereby a developing agent image in which the first developing agent image and the first transparent developing agent image are laminated in this order is obtained on the recording medium in the same manner as shown in FIG. 2.

An image forming apparatus shown in FIG. 12 has the same structure as that in FIG. 11 except that the intermediate transfer belt 7 is not used, the second developing device 4b and the first developing device 4a are disposed in the opposite order to that in FIG. 11, and the first developing agent image and the first transparent developing agent image are transferred directly onto the recording medium. As shown in FIG. 12, when the second developing device 4b and the first developing device 4a are disposed in the opposite order to that in FIG. 11, a developing agent image in which the first developing agent image and the first transparent developing agent image are laminated in this order is obtained on the recording medium in the same manner as shown in FIG. 2.

Further, although not shown, in FIGS. 1, and 10 to 12, the first image forming unit 17A and the second image forming unit 17B, or the first developing device 4a and the second developing device 4b on the photoconductive drum 1 can be disposed in the opposite order. In this case, opposite to FIG. 2, a developing agent image in which the first transparent developing agent image and the first developing agent image are laminated in this order is obtained on the recording medium.

FIG. 13 is a model diagram showing a way of fusing.

The heating roller 11 in FIG. 13 is configured such that an elastic layer (thickness: 2 mm) made of Si rubber and a protective layer (thickness: 30 μm) of PFA are laminated on SUS (outer diameter: 25 mm) with a thickness of 1 mm, and a halogen lamp 22 is mounted therein. The pressing roller 12 is configured such that an elastic layer (thickness: 8 mm) made of Si sponge is provided around a core rod made of Fe and having a diameter of 11 mm, and a pressure is applied such that a contact width (nip width) between the heating roller 11 and the pressing roller 12 becomes 8 mm. Accordingly, when the recording medium passes therethrough at 60 mm/sec and 120 mm/sec, the heating and pressing times are about 67 msec and about 133 msec, respectively.

FIG. 13 shows a way of fusing the developing agent image 100 in the same manner as shown in FIG. 2 in which the first developing agent image 101 and the first transparent developing agent image 102 are laminated in this order onto the recording medium.

When the fuser 21 is configured such that the heating roller 11 is disposed on the image side of the recording medium 13 and the pressing roller 12 is disposed on the back side of the recording medium 13 as shown in the drawing, the binder resin particles 102 to be melted by applying sufficient heat are melted by heating with the heating roller 11, and the encapsulated colorant microparticles 101′ in the obtained image 100′ do not directly come into contact with the heating roller 11, and therefore, the temperature of the microparticles 101′ hardly reaches the decolorizing temperature and the microparticles 101′ are sufficiently covered with the melted binder resin particles 102 easily. Accordingly, the fusing property tends to be enhanced.

Incidentally, as shown in FIG. 3, when the image in which the first transparent developing agent image 102 and the first developing agent image 101 are laminated in this order is fused onto the recording medium 13, if the heating roller 11 of the fuser is disposed on the back side of the recording medium by exchanging the positions of the heating roller 11 and the pressing roller 12 in FIG. 13, the binder resin particles 102 are easily melted by heat, and therefore, the fusing property tends to be enhanced.

As described above, according to the arrangement configuration of the encapsulated colorant microparticles and the binder resin particles in the developing agent image transferred onto the recording medium, the position of the heating roller of the fuser can be arbitrarily changed.

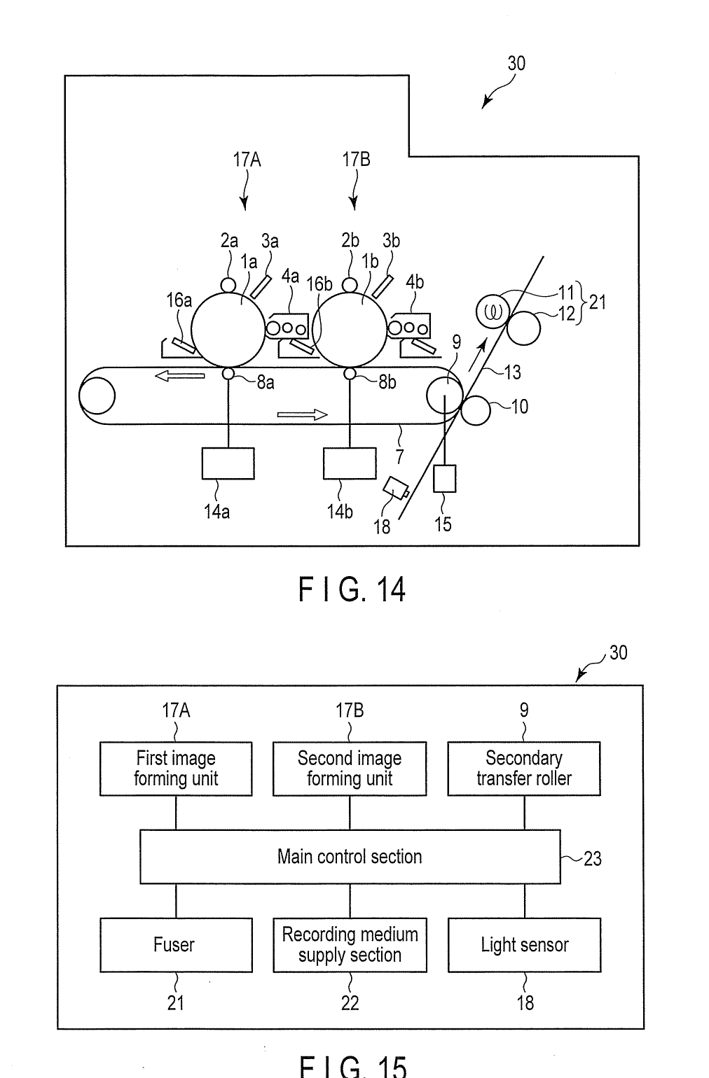

FIG. 14 is a view showing a schematic structure of another example of an image forming apparatus which can be used in the embodiment.

As shown in FIG. 14, an image forming apparatus 30 has the same structure as that in FIG. 1 except that a light sensor 18 is disposed just before a place where the recording medium 13 to be conveyed from a recording medium supply section (not shown) is fed between the secondary transfer roller 9 and the backup roller 10.

FIG. 15 is a block diagram showing one example of an image forming mechanism using the image forming apparatus of FIG. 14.

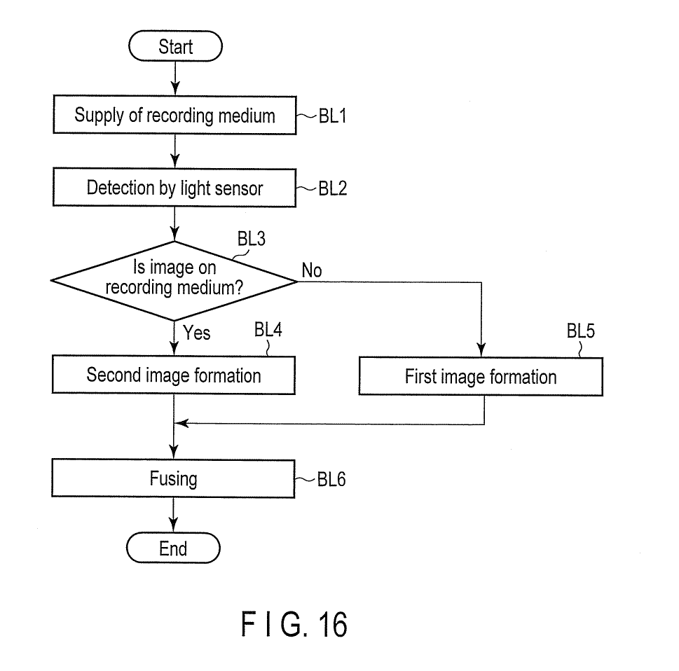

FIG. 16 is a flow chart showing one example of an image forming method using the image forming apparatus of FIG. 14.

As shown in FIG. 15, the first image forming unit 17A, the second image forming unit 17B, the secondary transfer roller 9, the fuser 21, the recording medium supply section 22, and the light sensor 18 are each connected to a main control section 23.

When the recording medium 13 is supplied from the recording medium supply section 22 (BL1), the light sensor 18 detects whether or not an image is on the recording medium 13 (BL2). The detection of an image can be performed on the basis of, for example, a difference in reflectance between the case when the decolorizable developing agent and the transparent developing agent forming the image are present on the recording medium 13 and the case when not present.

The presence or absence of an image on the recording medium is determined by the main control section 23 on the basis of the results of the light sensor 18 (BL3).

When an image is on the recording medium, a second image is formed (BL4).

In the second image formation, first, a second developing agent image is formed using the decolorizable developing agent in the first image forming unit, and thereafter, the supply amount of the transparent developing agent is determined by the main control section 23 for forming a transparent developing agent image at a second weight ratio which is lower than the first weight ratio. On the basis of this determination, a second transparent developing agent image is formed in the second image forming unit, or the formation of a second transparent developing agent image in the second image forming unit is canceled and only a second developing agent image obtained using the decolorizable developing agent is left as such. For example, when the first image is formed, a ratio of the weight of the transparent developing agent to the decolorizable developing agent is determined in advance as the first weight ratio and can be recorded on the recording medium.

On the other hand, when an image is not on the recording medium, in the same manner as the apparatus shown in FIG. 1, a first image can be formed according to first image information and first transparent image information using the first image forming unit 17A and the second image forming unit 17B (BL5).

By fusing the obtained first image or second image by the fuser 21 (BL6), an image can be formed.

Hereinafter, the color developable compound such as a leuco dye, the color developer, and the decolorizing agent to be used in the embodiment will be described.

The leuco dye refers to an electron donating compound which can develop a color by the action of a color developer. Examples thereof include diphenylmethane phthalides, phenylindolyl phthalides, indolyl phthalides, diphenylmethane azaphthalides, phenylindolyl azaphthalides, fluorans, styrynoquinolines, and diaza-rhodamine lactones.

Specific examples thereof include 3,3-bis(p-dimethylaminophenyl)-6-dimethylaminophthalide, 3-(4-diethylaminophenyl)-3-(1-ethyl-2-methylindol-3-yl)phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-0,0-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrano(2,3-d)pyrimidine-5,1′(3′H)isobenzofuran]-3′-one, 2-(diethylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-methyl-, spiro[5H-(1)benzopyrano(2,3-d)pyrimidine-5,1′(3′H)isobenzofuran]-3′-one, 2-(di-n-butylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(N-ethyl-N-1-amylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. Additional examples thereof include pyridine compounds, quinazoline compounds, and bisquinazoline compounds. These may be used by mixing two or more kinds thereof.

The color developer to be used in the embodiment is an electron accepting compound which donates a proton to a leuco dye. Examples thereof include phenols, metal salts of phenols, metal salts of carboxylic acids, aromatic carboxylic acids, aliphatic carboxylic acids having 2 to 5 carbon atoms, benzophenones, sulfonic acids, sulfonates, phosphoric acids, metal salts of phosphoric acids, acidic phosphoric acid esters, metal salts of acidic phosphoric acid esters, phosphorous acids, metal salts of phosphorous acids, monophenols, polyphenols, 1,2,3-triazole, and derivatives thereof. Additional examples thereof include those having, as a substituent, an alkyl group, an aryl group, an acyl group, an alkoxycarbonyl group, a carboxy group or an ester thereof, an amide group, a halogen group, or the like, and bisphenols, trisphenols, phenol-aldehyde condensed resins, and metal salts thereof. These compounds may be used by mixing two or more kinds thereof.

Specific examples thereof include phenol, o-cresol, tertiary butyl catechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acid or esters thereof such as methyl 2,3-dihydroxybenzoate and methyl 3,5-dihydroxybenzoate, resorcin, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl) ethane, 1,1-bis(4-hydroxyphenyl)-3-methylbutane, 1,1-bis(4-hydroxyphenyl)-2-methylpropane, 1,1-bis(4-hydroxyphenyl)-n-hexane, 1,1-bis(4-hydroxyphenyl)-n-heptane, 1,1-bis(4-hydroxyphenyl)-n-octane, 1,1-bis(4-hydroxyphenyl)-n-nonane, 1,1-bis(4-hydroxyphenyl)-n-decane, 1,1-bis(4-hydroxyphenyl)-n-dodecane, 2,2-bis(4-hydroxyphenyl)butane, 2,2-bis(4-hydroxyphenyl)ethyl propionate, 2,2-bis(4-hydroxyphenyl)-4-methylpentane, 2,2-bis(4-hydroxyphenyl)hexafluoropropane, 2,2-bis(4-hydroxyphenyl)-n-heptane 2,2-bis(4-hydroxyphenyl)-n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol, and methylenetris-p-cresol.

In a three-component system containing a color developable compound, a color developer, and a decolorizing agent, as the decolorizing agent to be used in the embodiment, a known compound can be used as long as the compound inhibits the coloring reaction between the leuco dye and the color developer, thereby making a material colorless through heating.

Examples of the form of the decolorizing agent include 1) a form in which a component in a colored state resulting from binding a leuco dye and a color developer and a decolorizing agent component are dispersed in a medium which has low or no coloring and decolorizing actions and 2) a form in which a decolorizing agent component is used as a medium for a component in a colored state resulting from binding a leuco dye and a color developer.

With respect to the decolorizing agent to be used in the form of 2), particularly, the coloring and decolorizing mechanism utilizing the thermal hysteresis of a known decolorizing agent disclosed in JP-A-60-264285, JP-A-2005-1369, JP-A-2008-280523, or the like is excellent in instantaneous erasing property. When a mixture of such a three-component system in a colored state is heated to a specific decolorizing temperature (Th) or higher, the mixture can be decolorized. Further, even if the decolorized mixture is cooled to a temperature lower than Th, the decolorized state is maintained. When the temperature of the mixture is further decreased, a coloring reaction between the leuco dye and the color developer is restored at a specific color restoring temperature (Tc) or lower to return to the colored state. In this manner, it is possible to cause a reversible coloring and decolorizing reaction. In particular, it is preferred that the decolorizing agent to be used in the embodiment satisfies the following relationship: Th>Tr>Tc, wherein Tr represents room temperature.

Examples of the decolorizing agent capable of causing this thermal hysteresis include alcohols, esters, ketones, ethers, and acid amides.

Particularly preferred are esters. Specific examples thereof include esters of carboxylic acids containing a substituted aromatic ring, esters of carboxylic acids containing an unsubstituted aromatic ring with aliphatic alcohols, esters of carboxylic acids containing a cyclohexyl group in each molecule, esters of fatty acids with unsubstituted aromatic alcohols or phenols, esters of fatty acids with branched aliphatic alcohols, esters of dicarboxylic acids with aromatic alcohols or branched aliphatic alcohols, dibenzyl cinnamate, heptyl stearate, didecyl adipate, dilauryl adipate, dimyristyl adipate, dicetyl adipate, distearyl adipate, trilaurin, trimyristin, tristearin, dimyristin, and distearin. These may be used by mixing two or more kinds thereof.

As the decolorizing agent to be used in the form of 1), a decolorizing agent known in JP-A-2000-19770 or the like can be used. Examples thereof include cholesterol, stigmasterol, pregnenolone, methylandrostenediol, estradiol benzoate, epiandrostene, stenolone, β-sitosterol, pregnenolone acetate, β-chorestanol, 5,16-pregnadiene-3β-ol-20-one, 5α-pregnen-3β-ol-20-one, 5-pregnen-3β, 17-diol-20-one-21-acetate, 5-pregnen-3β, 17-diol-20-one-17-acetate, 5-pregnen-3β, 21-diol-20-one-21-acetate, 5-pregnen-3β, 17-diol diacetate, rockogenin, thigogenin, esmiragenin, heckogenin, diosgenin, cholic acid, methyl cholate, sodium cholate, lithocholic acid, methyl lithocholate, sodium lithocholate, hydroxycholic acid, methyl hydroxycholate, hyodeoxycholic acid, methyl hyodeoxycholate, testosterone, methyltestosterone, 11α-hydroxymethyltestosterone, hydrocortisone, cholesterol methyl carbonate, α-cholestanol, D-glucose, D-mannose, D-galactose, D-fructose, L-sorbose, L-rhamnose, L-fucose, D-ribodesose, α-D-glucose pentaacetate, acetoglucose, diacetone-D-glucose, D-glucuronic acid, D-galacturonic acid, D-glucosamine, D-fructosamine, D-isosaccharic acid, vitamin C, erutorubic acid, trehalose, saccharose, maltose, cellobiose, gentiobiose, lactose, melibiose, raffinose, gentianose, melizitose, stachyose, methyl α-glucopyranoside, salicin, amygdalin, euxanthic acid, cyclododecanol, hexahydrosalicylic acid, menthol, isomenthol, neomenthol, neoisomenthol, carbomenthol, α-carbomenthol, piperithol, α-terpineol, β-terpineol, γ-terpineol, 1-p-menthene-4-ol, isopulegol, dihydrocarveol, carveol, 1,4-cyclohexanediol, 1,2-cyclohexanediol, phloroglucitol, quercitol, inositol, 1,2-cyclododecanediol, quinic acid, 1,4-terpene, 1,8-terpene, pinol hydrate, betulin, borneol, isoborneol, adamantanol, norborneol, fenchol, camphor, and 1,2;5,6-diisopropylidene-D-mannitol.

The mixing ratio of each of the leuco dye, the color developer, and the decolorizing agent varies depending on the concentration, discoloring temperature, or type of each component, however, in terms of weight ratio with respect to the leuco dye whose weight is taken as 1, the ratio of the color developer is from 0.1 to 100, preferably from 0.1 to 50, more preferably from 0.5 to 20, and the ratio of the decolorizing agent is from 1 to 800, preferably from 5 to 200, more preferably from 5 to 100.

### EXAMPLES

### Preparation of Encapsulated Colorant Microparticles and Developer

### Encapsulated Colorant Microparticles (1)

A decolorizable toner composition composed of 1 part by weight of 3-(2-ethoxy-4-diethylaminophenyl)-3-(1-ethyl-2-methylindol-3-yl)-4-azaphthalide as a color developable compound, 5 parts by weight of 2,2-bis(4′-hydroxyphenyl)hexafluoropropane as a color developer, and 50 parts by weight of diester of pimelic acid and 2-(4-benzyloxyphenyl)ethanol as a decolorizing agent was uniformly dissolved by heating, whereby a core solution was obtained.

In 25 parts by weight of a color developable compound composition, 25 parts by weight of an aromatic polyvalent isocyanate prepolymer as a wall film material and 25 parts by weight of ethyl acetate as a solubilizing agent were mixed, whereby a core-shell solution was obtained.

The core-shell solution was emulsified and dispersed to form microdroplets in an aqueous solution of polyvinyl alcohol. After stirring of the dispersion was continued while heating, a water-soluble aliphatic modified amine was added thereto, and the stirring of the dispersion was further continued, whereby a suspension of encapsulated colorant microparticles was obtained. The thus obtained suspension was centrifuged, whereby encapsulated colorant microparticles (1) were isolated. The encapsulated colorant microparticles (1) have a volume average particle diameter of 5 μm, a completely decolorizing temperature of 79° C., and a completely coloring temperature of −10° C., and reversibly change the color from blue to colorless according to a change in temperature.

### Developer A1

In 100 parts by weight of the above-obtained encapsulated colorant microparticles (1), 3 parts by weight of silica (NAX50, manufactured by Japan Aerosil Co., Ltd.) and 1.2 parts by weight of titanium oxide (NKT90, manufactured by Japan Aerosil Co., Ltd.) were mixed, and the resulting mixture was sufficiently stirred, whereby the inorganic microparticles were uniformly adhered to the surfaces of the encapsulated colorant microparticles (1).

6 Parts by weight of the above-obtained particles and 94 parts by weight of carrier particles obtained by coating the surface of ferrite having a volume average particle diameter of 40 μm with an acrylic resin were mixed, whereby a developing agent A1 was obtained. The developing agent A1 was charged to have an average charging amount of −23 μC/g.

### Encapsulated Colorant Microparticles (2)

A decolorizable toner composition composed of 1 part by weight of crystal violet lactone as a color developable compound, 5 parts by weight of benzyl 4-hydroxybenzoate as a color developer, and 50 parts by weight of 4-benzyloxyphenylethyl laurate as a decolorizing agent was uniformly dissolved by heating, whereby a core solution was obtained.

In 25 parts by weight of a color developable compound composition, a solution obtained by mixing 25 parts by weight of an aromatic polyvalent isocyanate prepolymer as a wall film material and 50 parts by weight of ethyl acetate as a solubilizing agent was mixed, whereby a core-shell solution was obtained.

The core-shell solution was emulsified and dispersed to form microdroplets in an aqueous solution of polyvinyl alcohol. After stirring of the dispersion was continued while heating, a water-soluble aliphatic modified amine was added thereto, and the stirring of the dispersion was further continued, whereby a suspension of encapsulated colorant microparticles was obtained. The thus obtained suspension was centrifuged, whereby encapsulated colorant microparticles (2) were isolated. The encapsulated colorant microparticles (2) have a volume average particle diameter of 5 μm, a completely decolorizing temperature of 103° C., and a completely coloring temperature of −15° C., and reversibly change the color from blue to colorless according to a change in temperature.

### Developer A2

In 100 parts by weight of the above-obtained encapsulated colorant microparticles (2), 3 parts by weight of silica (NAX50, manufactured by Japan Aerosil Co., Ltd.) and 1.2 parts by weight of titanium oxide (NKT90, manufactured by Japan Aerosil Co., Ltd.) were mixed, and the resulting mixture was sufficiently stirred, whereby the inorganic microparticles were uniformly adhered to the surfaces of the encapsulated colorant microparticles (2). 6 Parts by weight of the above-obtained particles and 94 parts by weight of carrier particles obtained by coating the surface of ferrite having a volume average particle diameter of 40 μm with an acrylic resin were mixed, whereby a developing agent A2 was obtained. The developing agent A2 was charged to have an average charging amount of −25 μC/g.

### Preparation of Binder Resin Particles and Developer Resin Particles (1)

39 Parts by weight of terephthalic acid, 61 parts by weight of an ethylene oxide compound of bisphenol A, and 0.2 parts by weight of dibutyltin were placed in an esterification reactor, and a polycondensation reaction was performed in a nitrogen atmosphere at 260° C. and 50 KPa, for 5 hours, whereby a polyester resin was obtained.

The obtained polyester resin has a glass transition temperature (Tg) of 60° C., a softening point (Tm) of 110° C., and a weight average molecular weight of 12000. In 95 parts by weight of the obtained polyester resin, 5 parts by weight of a release agent (rice wax) was mixed, and the resulting mixture was kneaded, ground, and classified, whereby resin particles (1) having a volume average particle diameter of 9.8 μm were obtained.

In 100 parts by weight of the thus obtained resin particles (1), 1.7 parts by weight of silica (NAX50) and 0.6 parts by weight of titanium oxide (NKT90) were mixed, and the resulting mixture was sufficiently stirred, whereby the inorganic microparticles were uniformly adhered to the surfaces of the resin particles (1). 8 parts by weight of the above-obtained particles and 92 parts by weight of carrier particles obtained by coating the surface of ferrite having a volume average particle diameter of 40 μm with an acrylic resin were mixed, whereby a developing agent B1 was obtained. The developing agent B1 was charged to have an average charging amount of −31 μC/g.

Incidentally, the measurement of the softening point was performed using a flow tester (CFT-500D) manufactured by Shimadzu Corporation as follows. A sample (1.45 to 1.50 g) was molded by a pressing device and placed in a cylinder of the flow tester. The conditions were set as follows: a temperature raising rate: 2.5° C./min, a die hole diameter: 1 mm, a load: 10 kgf, and an air pressure: 0.4 MPa. A temperature when a stroke is positioned at a middle point between a softening point and a flow end point is taken as the softening point (Tm).

### Preparation of Dispersion Liquid of Binder Resin Particles

The above-obtained polyester resin was ground, and 0.4 parts by weight of sodium dodecylbenzene sulfonate and 1 part by weight of triethylamine were added thereto, whereby a suspension was prepared. Thereafter, the particle size was reduced by mechanical shearing using a high-pressure homogenizer, whereby a dispersion liquid of particles containing a binder resin was prepared as a core solution.

### Preparation of Styrene-Acrylic Resin as Shell Material

90 Parts by weight of styrene, 10 parts by weight of n-butylacrylate, 100 ppm of sodium p-styrenesulfonate, 1.5 parts by weight of tert-dodecylmercaptan as a chain transfer agent, and 0.5 parts by weight of LATEMUL PS manufactured by Kao Corporation as an emulsifying agent were added, and further 0.8 parts by weight of ammonium persulfate as a polymerization initiator was added and emulsion polymerization was performed at 60° C., whereby an emulsion liquid of a styrene-acrylic resin was obtained as a shell solution. The styrene-acrylic resin has a glass transition temperature of 80° C. and a weight average molecular weight of 25000.

### Aggregation and Fusing Steps

95 Parts by weight of the above-prepared dispersion liquid of particles containing a binder resin and 5 parts by weight of a dispersion liquid of a release agent (rice wax) were aggregated at 50° C. using 3.0% by weight of aluminum sulfate [Al₂(SO₄)₃], and further 20 parts by weight of the above-prepared emulsion liquid of a styrene-acrylic resin was added thereto, whereby the resin particles were encapsulated. Thereafter, the temperature was raised to 75° C. at a temperature raising rate of 5° C. per 30 minutes to perform fusion, followed by washing and drying, whereby resin particles (2) having a volume average particle diameter of 10.3 μm were obtained.

In 100 parts by weight of the thus obtained resin particles (2), 1.6 parts by weight of silica (NAX50) and 0.5 parts by weight of titanium oxide (NKT90) were mixed, and the resulting mixture was sufficiently stirred, whereby the inorganic microparticles were uniformly adhered to the surfaces of the resin particles (2). 8 Parts by weight of the above-obtained particles and 92 parts by weight of carrier particles obtained by coating the surface of ferrite having a volume average particle diameter of 40 μm with an acrylic resin were mixed, whereby a developing agent B2 was obtained. The developing agent B2 was charged to have an average charging amount of −32 μC/g.

### Example 1

By using the image forming apparatus shown in FIG. 1, the developing agent B1 was accommodated in the second developing device 4b, and the developing agent A1 was accommodated in the first developing device 4a.

The encapsulated colorant microparticles (1) and the resin particles (1) were transferred in the form of an image onto a recording medium.

At this time, the encapsulated colorant microparticles and the resin particles were separately transferred onto a recording medium, respectively, and the recording medium was taken out before fusing, and unfused particles were removed by being blown off from the recording medium. The weight of the recording medium was measured before and after the removal of the particles, and the using amount of the encapsulated colorant microparticles (1) and the using amount of the resin particles (1) were measured. The using amount of the encapsulated colorant microparticles (1) was 0.02 mg/cm², and the using amount of the resin particles (1) was 0.2 mg/cm², and the weight ratio of the resin particles (1) to the encapsulated colorant microparticles (1) (first weight ratio) was 10.

The temperature of the fuser was set to 73° C. In this case, by passing the recording medium through the fuser at a rate of about 60 mm/sec (15 ppm), the binder resin for fusing is melted by heating and pressing in the nip of the fuser without causing the colorant to reach a decolorizing temperature and the melted binder resin wraps around the colorant particles. Thereafter, the recording medium exits from the fuser and is cooled, as a result, a colored image fused on the recording medium can be obtained.

By heating the colored image to 79° C. or higher by a decolorizing device (not shown), the colorant was decolorized. The recording medium can be reused as a white paper.

Subsequently, the recording medium having a decolorized image was fed to the image forming apparatus shown in FIG. 1 again, and the encapsulated colorant microparticles (1) and the resin particles (1) were transferred in the form of an image onto the recording medium by decreasing the using amount of the resin particles (1) such that the weight ratio of the using amount of the resin particles (1) to the using amount of the encapsulated colorant microparticles (1) (second weight ratio) is lower than the first weight ratio.

At this time, the second weight ratio was 0.25.

Fusing was performed in the same manner as above, and a sufficient image could be formed.

Further, the image was erased in the same manner as above, the colorant was decolorized. The recording medium can be reused as a white paper.

Subsequently, a comparative example will be described. In the comparative example, an image is developed using one type of developing agent in which the colorant particles and the resin particles are contained together. For example, a developing agent is formed such that the ratio of the colorant to the resin is 1:5. When one sheet of paper is used 5 times, if the printing ratio is the same in each printing operation, the colorant and the resin are consumed on the recording medium in amounts of 5 and 25, respectively. However, if the embodiment is adopted, for example, in the case of Example 1, the colorant and the resin are consumed in amounts of 5 and 11, respectively. As the number of reuse times increases, the consumption amount of the resin decreases.

### Example 2

The developing agent B2 was accommodated in the developing device 4b and the developing agent A2 was accommodated in the developing device 4a. Then, the encapsulated colorant microparticles (2) and the resin particles (2) were transferred in the form of an image onto a recording medium. The temperature of the fuser was set to 85° C. In this case, by passing the recording medium through the fuser at a rate of about 120 mm/sec (28 ppm), the binder resin for fusing is melted by heating and pressing in the nip of the fuser without causing the colorant to reach a decolorizing temperature and the melted binder resin wraps around the colorant particles. Thereafter, the recording medium exits from the fuser and is cooled, as a result, a colored image fused on the recording medium can be obtained.

By heating the colored image to 103° C. or higher by a decolorizing device (not shown), the colorant was decolorized. The recording medium can be reused as a white paper.

Subsequently, the recording medium having a decolorized image was fed to the image forming apparatus shown in FIG. 1 again, and the encapsulated colorant microparticles (2) were transferred in the form of an image onto the recording medium without using the resin particles (2).

Fusing was performed in the same manner as above, and a sufficient image could be formed.

Further, the image was erased in the same manner as above, the colorant was decolorized. The recording medium can be reused as a white paper.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming method comprising first image formation and second image formation, wherein
the first image formation includes:
forming a decolorizable first developing agent image by developing an electrostatic latent image formed in accordance with first image information on a first image carrying member using a decolorizable developing agent containing encapsulated colorant microparticles each including a core containing a color developable compound, a color developer, and a decolorizing agent;
forming a first transparent developing agent image by developing an electrostatic latent image formed in accordance with first transparent image information for forming an image capable of covering the first developing agent image on a second image carrying member using a transparent developing agent containing a binder resin at a first weight ratio to the weight of the decolorizable developing agent used in the first developing agent image;
forming a first transfer image by transferring the first developing agent image and the first transparent developing agent image onto a transfer material; and
fusing the first transfer image onto the transfer material at a fusing temperature,
and the second image formation includes:
forming a decolorizable second developing agent image by developing an electrostatic latent image formed in accordance with second image information on the first image carrying member using the decolorizable developing agent;
forming a second transfer image by transferring the second developing agent image onto the transfer material having the first image formed thereon; and
fusing the second transfer image onto the transfer material at a fusing temperature.

2. The method according to claim 1, wherein the second image formation further includes, before fusing the second transfer image onto the transfer material at a fusing temperature:
forming a second transparent developing agent image by developing an electrostatic latent image formed in accordance with second transparent image information which enables the formation of an image capable of covering at least a portion of the second developing agent image on the second image carrying member using the transparent developing agent at a second weight ratio, which is lower than the first weight ratio, to the weight of the decolorizable developing agent used in the second developing agent image; and
forming the second transfer image by transferring the second transparent developing agent image along with the second developing agent image onto the transfer material.

3. The method according to claim 1, wherein before forming the second image, the first image is decolorized at a decolorizing temperature which is higher than the fusing temperature.

4. The method according to claim 2, wherein the decolorizable developing agent has a hysteresis characteristic of maintaining a decolorized state even if the temperature of the decolorizable developing agent is decreased to a temperature lower than the decolorizing temperature.

5. The method according to claim 1, wherein the first transfer image is temporarily transferred onto an intermediate transfer member and thereafter retransferred onto the transfer material, and the second transfer image is temporarily transferred onto an intermediate transfer member and thereafter retransferred onto the transfer material.

6. The method according to claim 1, wherein the first image carrying member also functions as the second image carrying member.

7. An image forming method comprising:
detecting whether or not an image including a decolorizable developing agent image formed using a decolorizable developing agent containing encapsulated colorant microparticles each including a core containing a color developable compound, a color developer, and a decolorizing agent and a transparent developing agent image formed using a transparent developing agent containing a binder resin is on a transfer material; and
when the image is determined to be not on the transfer material, the method further comprising:
forming a decolorizable first developing agent image by developing an electrostatic latent image formed in accordance with first image information on a first image carrying member using the decolorizable developing agent;
forming a first transparent developing agent image by developing an electrostatic latent image formed in accordance with first transparent image information for forming an image capable of covering the first developing agent image on a second image carrying member using the transparent developing agent at a first weight ratio to the weight of the decolorizable developing agent used in the first developing agent image;
forming a first transfer image by transferring the first developing agent image and the first transparent developing agent image onto the transfer material; and
forming a first image by fusing the first transfer image onto the transfer material at a fusing temperature, and
when the image is determined to be on the transfer material, the method further comprising:
forming a decolorizable second developing agent image by developing an electrostatic latent image formed in accordance with second image information on the first image carrying member using the decolorizable developing agent;
forming a second transfer image by transferring the second developing agent image onto the transfer material having the first image formed thereon; and
forming a second image by fusing the second transfer image onto the transfer material at a fusing temperature.

8. The method according to claim 7, wherein when forming the second image, the method further comprises, before fusing the second transfer image onto the transfer material at a fusing temperature:
forming a second transparent developing agent image by developing an electrostatic latent image formed in accordance with second transparent image information which enables the formation of an image capable of covering at least a portion of the second developing agent image on the second image carrying member using the transparent developing agent at a second weight ratio, which is lower than the first weight ratio, to the weight of the decolorizable developing agent used in the second developing agent image; and
forming the second transfer image by transferring the second transparent developing agent image along with the second developing agent image onto the transfer material.

9. The method according to claim 7, wherein the image to be detected is decolorized in advance at a decolorizing temperature which is higher than the fusing temperature.

10. The method according to claim 7, wherein the decolorizable developing agent has a hysteresis characteristic of maintaining a decolorized state even if the temperature of the decolorizable developing agent is decreased to a temperature lower than the decolorizing temperature.

11. The method according to claim 7, wherein the first transfer image or the second transfer image is temporarily transferred onto an intermediate transfer member and thereafter retransferred onto the transfer material.

12. The method according to claim 7, wherein the first image carrying member also functions as the second image carrying member.

13. An image forming method comprising:
forming a first transparent developing agent image having a uniform pattern on a first image carrying member using a transparent developing agent containing a binder resin;
forming a decolorizable first developing agent image on a second image carrying member by developing an electrostatic latent image formed in accordance with first image information for forming an image in a region of the first transparent developing agent image using a decolorizable developing agent containing encapsulated colorant microparticles each including a core containing a color developable compound, a color developer, and a decolorizing agent;
forming a first transfer image by transferring the first developing agent image and the first transparent developing agent image onto a transfer material; and
forming a first image by fusing the first transfer image at a fusing temperature.

14. The method according to claim 13 further comprising:
forming a decolorizable second developing agent image by developing an electrostatic latent image formed in accordance with second image information on the second image carrying member using the decolorizable developing agent;
forming a second transfer image by transferring the second developing agent image onto the transfer material having the first image formed thereon; and
forming a second image by fusing the second transfer image at a fusing temperature.

15. The method according to claim 14 further comprising, before forming the second developing agent image:
forming a second transparent developing agent image by developing an electrostatic latent image formed in accordance with second transparent image information using the transparent developing agent at a second weight ratio, which is lower than a first weight ratio, to the weight of the decolorizable developing agent used in the second developing agent image, wherein the first weight ratio represents a ratio of the weight of the transparent developing agent used in the first transparent developing agent image to the weight of the decolorizable developing agent used in the first developing agent image; and
forming the second transfer image by transferring the second transparent developing agent image along with the second developing agent image onto the transfer material having the first image formed thereon.

16. The method according to claim 14, wherein before forming the second image, the first image is decolorized at a decolorizing temperature which is higher than the fusing temperature.

17. The method according to claim 13, wherein the decolorizable developing agent has a hysteresis characteristic of maintaining a decolorized state even if the temperature of the decolorizable developing agent is decreased to a temperature lower than the decolorizing temperature.

18. The method according to claim 13, wherein the first transfer image is temporarily transferred onto an intermediate transfer member and thereafter retransferred onto the transfer material.

19. The method according to claim 14, wherein the first transfer image is temporarily transferred onto an intermediate transfer member and thereafter retransferred onto the transfer material, and the second transfer image is temporarily transferred onto an intermediate transfer member and thereafter retransferred onto the transfer material.

20. The method according to claim 13, wherein the first image carrying member also functions as the second image carrying member.
